(19) United States
(12) Patent Application Publication
(10) Pub. No.: US 2011/0126019 A1
(43) Pub. Date: May 26, 2011

(54) ALTERING FUNCTIONALITY FOR CHILD-FRIENDLY CONTROL DEVICES

(75) Inventors: Ian Epperson, Sunnyvale, CA (US); Brian Sweet, Waterloo (CA); Michael Malcolm, Aspen, CO (US); Richard Oei, Kitchener (CA)

(73) Assignee: KALEIDESCAPE, INC., Sunnyvale, CA (US)

(21) Appl. No.: 12/626,513

(22) Filed: Nov. 25, 2009

(51) Int. Cl. H04L 9/32; G06F 3/00

(52) U.S. Cl. 713/176; 715/762

(57) ABSTRACT

A method of interacting with a digital content device is described. The method includes defining a collection of digital content available via the digital content device. A specific control device is associated with the collection of digital content. A control signal is received from the control device. The digital content device allows the control device to access digital content included in the collection.

### CROSS REFERENCE TO RELATED APPLICATIONS

This application is related to copending application U.S. patent application Ser. No. ______, attorney docket no. 1042.01, entitled ALTERING FUNCTIONALITY FOR DIFFERENT CONTROL DEVICES by Epperson et al., filed on ______. This application is hereby incorporated by reference as if fully set forth herein.

### BACKGROUND

1. Field of the Invention

Embodiments of the present invention relate to controlling digital content devices.

2. Related Art

The proliferation of digital media content, in combination with inexpensive storage devices and digital distribution channels, allows an individual to collect a tremendous amount of content on a single device. For example, a user might have thousands of digital audio files stored on their desktop computer, hundreds of movies stored on a media server, or dozens of video games downloaded for a game console. Organizing and accessing all of this content presents a number of new challenges.

Further, the devices used for storing and accessing digital content are becoming increasingly complex. A single game console, for example, may serve as a media server, for playback of movies; a digital jukebox, for playback of audio files; and a server device, for allowing a handheld game console to access additional content, in addition to its “normal” functionality for playing games.

### SUMMARY

A method of interacting with a digital content device is described. The method includes defining a collection of digital content available via the digital content device. A specific control device is associated with the collection of digital content. A control signal is received from the control device. The digital content device allows the control device to access digital content included in the collection.

A digital content device is described. The digital content device comprises a processor, for executing software instructions to control the digital content device. An output module is coupled to the processor, for outputting a signal. A storage module is coupled to the processor, for storing digital content. A control system is coupled to the processor, for receiving a control signal from a control device associated with specific functionality of the digital content device. Upon receipt of the control signal from the control device, the processor is configured to allow the control device to access a subset of digital content stored upon the storage module.

A computer-readable medium is described, having computer-executable instructions for performing a method. The method comprises recognizing a control signal from a specific control device. The method also involves reducing the available functionality of a digital content device to a specified mode of operation associated with the specific control device.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary computer system, upon which embodiments may be implemented.

FIG. 2 depicts an exemplary media server environment, in accordance with one embodiment.

FIG. 3 depicts an exemplary media server environment, in accordance with one embodiment.

FIG. 4 depicts a plurality of control devices, suitable in some embodiments for controlling a media player.

FIG. 5 depicts a graphical user interface, in accordance with one embodiment.

FIG. 6 depicts a child friendly remote control, in accordance with one embodiment.

FIG. 7 depicts a graphical user interface, in accordance with one embodiment.

FIG. 8 depicts a flowchart of a method, in accordance with one embodiment.

FIG. 9 depicts a flowchart of a method, in accordance with one embodiment.

FIG. 10A depicts a flowchart of a method, in accordance with one embodiment.

FIG. 10B depicts a flowchart of a method, in accordance with one embodiment.

FIG. 10C depicts a flowchart of a method, in accordance with one embodiment.

### DETAILED DESCRIPTION

Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

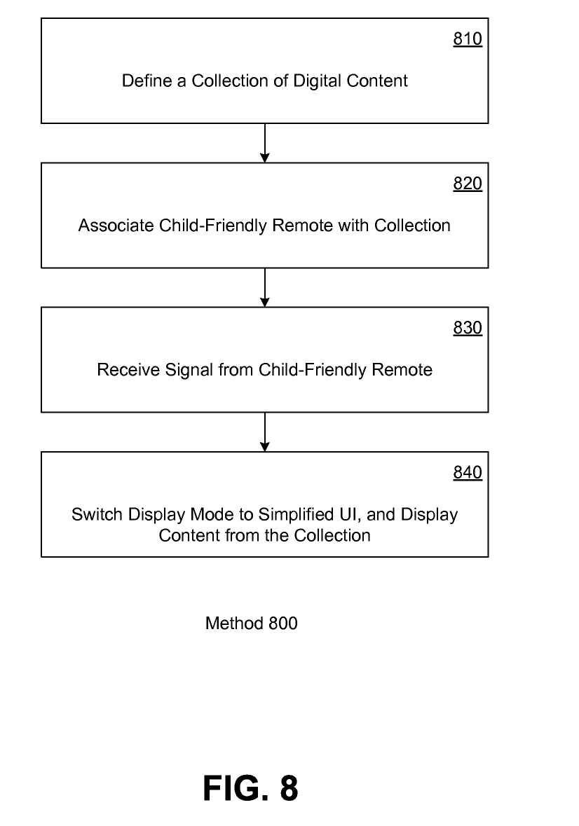

Portions of the detailed description that follows are presented and discussed in terms of a method. Although steps and sequencing thereof are disclosed in figures herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

### Basic Computing System

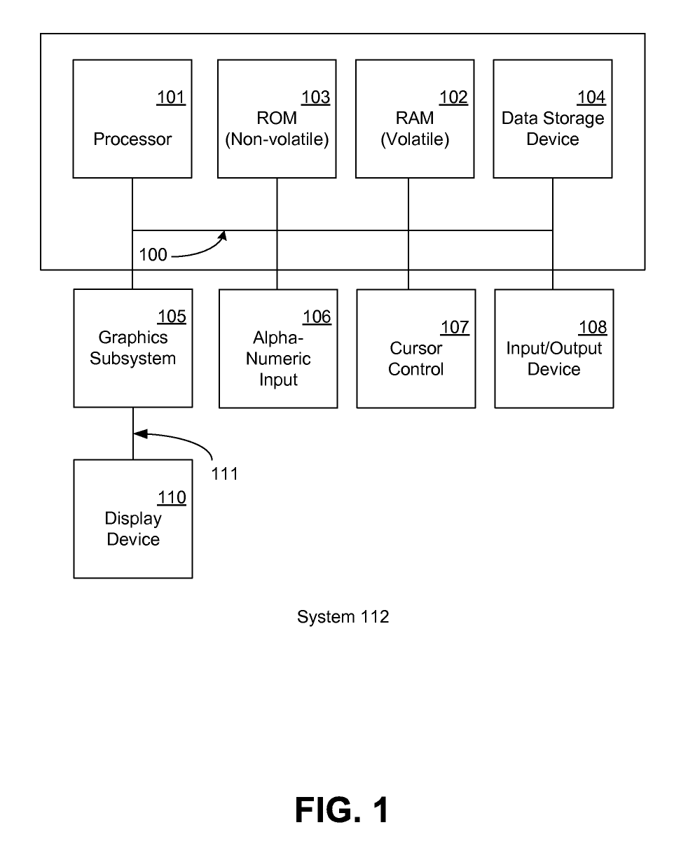

Referring now to FIG. 1, a block diagram of an exemplary computer system 112 is shown. It is appreciated that computer system 112 described herein illustrates an exemplary configuration of an operational platform upon which embodiments may be implemented to advantage. Nevertheless, other computer systems with differing configurations can also be used in place of computer system 112 within the scope of the present invention. For example, computer system 112 may include additional, fewer, or different elements other than those described in conjunction with FIG. 1. Moreover, embodiments may be practiced on any system which can be configured to enable it, not just computer systems like computer system 112. It is understood that embodiments can be practiced on many different types of computer system 112. System 112 can be implemented as, for example, a desktop computer system or server computer system having a powerful general-purpose CPU coupled to a dedicated graphics rendering GPU. In such an embodiment, components can be included that add peripheral buses, specialized audio/video components, IO devices, and the like. Similarly, system 112 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan. System 112 can also be implemented as a “system on a chip”, where the electronics (e.g., the components 101, 103, 105, 106, and the like) of a computing device are wholly contained within a single integrated circuit die. Examples include a hand-held instrument with a display, a car navigation system, a portable entertainment system, and the like.

Computer system 112 comprises an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, etc.) coupled with bus 100 for storing static information and instructions for processor 101. Moreover, computer system 112 also comprises a data storage device 104 (e.g., hard disk drive) for storing information and instructions.

Computer system 112 also comprises an optional graphics subsystem 105, an optional alphanumeric input device 106, an optional cursor control or directing device 107, and signal communication interface (input/output device) 108. Optional alphanumeric input device 106 can communicate information and command selections to central processor 101. Optional cursor control or directing device 107 is coupled to bus 100 for communicating user input information and command selections to central processor 101. Signal communication interface (input/output device) 108, which is also coupled to bus 100, can be a serial port. Communication interface 108 may also include wireless communication mechanisms. Using communication interface 108, computer system 112 can be communicatively coupled to other computer systems over a communication network such as the Internet or an intranet (e.g., a local area network), or can receive data (e.g., a digital television signal). Computer system 112 may also comprise graphics subsystem 105 for presenting information to the computer user, e.g., by displaying information on an attached display device 110, connected by a video cable 111. In some embodiments, graphics subsystem 105 is incorporated into central processor 101. In other embodiments, graphics subsystem 105 is a separate, discrete component. In other embodiments, graphics subsystem 105 is incorporated into another component. In other embodiments, graphics subsystem 105 is included in system 112 in other ways.

### Controlling Access to Digital Content Devices

One challenge, as regards the proliferation of digital content, is determining who is allowed to access which content. Limiting accessibility of content may be necessary or desirable for a number of different reasons. For example, children may need to be prevented from accessing certain content, either because it is inappropriate or because they have no interest in the content. Similarly, different adults users may need or want access to different portions of the available content, based on differing inclinations or, potentially, licensing terms. Even without limiting accessibility to content, different users may prefer access to the content to be displayed in a particular manner.

A related challenge involves the often complex functionality available through devices used for storing and accessing digital content. As previously noted, even a “simple” device such as a video game console offers a tremendous amount of functionality. At times, altering, or even limiting, the functionality available may be useful. A child, for example, likely does not need access to complicated stereo controls in order to play back their favorite movie from the media server. A user who powers on their video game console using a guitar-shaped video game controller probably does not want access to movie download or playback functionality.

Embodiments described herein attempt to address these challenges. In several such embodiments, digital content devices are configured to respond differently to different control devices. This approach allows, for example, a remote control to be configured for “child-friendly” functionality, such that anyone using exact remote control is limited to a specific collection of content available from a media server. Similarly, use of one specific control device may allow for a certain subset of functionality from a digital content device, while a different control device may allow access to a different set of functions.

### Exemplary Media Server Environment

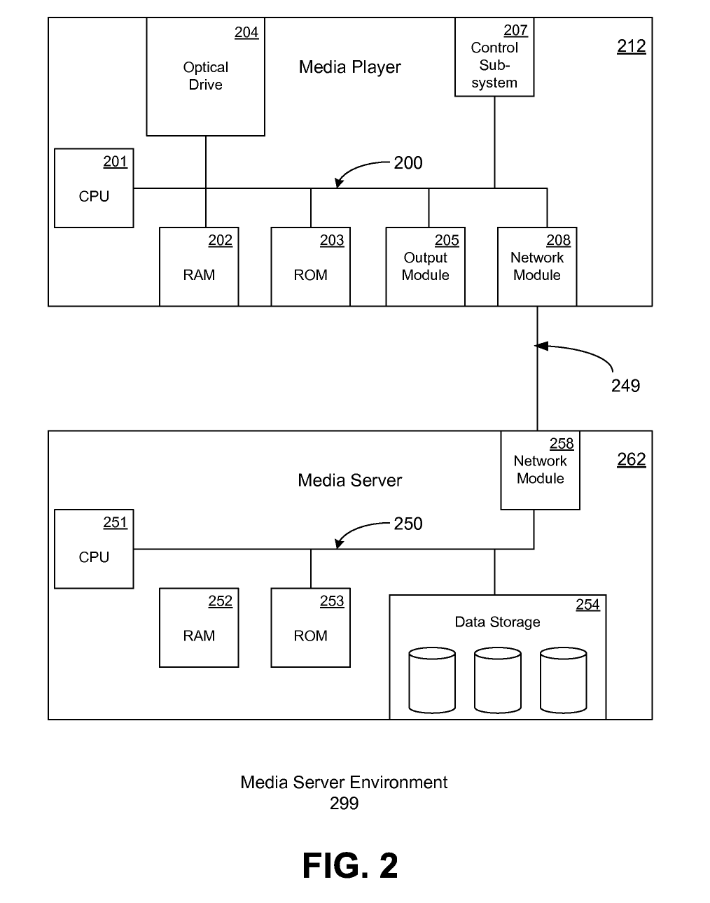

With reference now to FIG. 2, an exemplary media server environment 299 is depicted, in accordance with one embodiment. While media server environment 299 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 299 is shown as comprising two devices: media player 212, and media server 262. Media player 212 includes: bus 200 for communicating information; a central processor 201 coupled with bus 200 for processing information and instructions; a volatile memory unit 202 (e.g., random access memory [RAM], static RAM, dynamic RAM, etc.) coupled with bus 200 for storing information and instructions for central processor 201; and a non-volatile memory unit 203 (e.g., read only memory [ROM], programmable ROM, flash memory, etc.) coupled with bus 200 for storing static information and instructions for processor 201. Moreover, media player 212 incorporates optical drive 204, coupled with bus 200, for accessing data stored on optical media, e.g., CDs or DVDs. Media player 212 also incorporates output module 205, coupled with bus 200, for outputting audio and/or video data. Media player 212 is also shown as incorporating networking module 208, coupled with bus 200, for transmitting and receiving information, e.g., over a network connection. In the depicted embodiment, media player 212 also incorporates control subsystem 207. Control subsystem 207 is coupled with bus 200, and receives control signals for controlling the functionality of media player 212, as well as for manipulating digital content being played on media player 212.

As shown in the depicted embodiment, media player 212 is communicatively coupled to media server 262 via network connection 249. In different embodiments, network connection 249 may be implemented in different ways. For example, network connection 249 may be implemented as a TCP/IP connection, transmitted via Ethernet or a wireless connection.

Media server 262 includes: bus 250 for indicating information; a CPU 251 coupled with bus 250 for processing information and instructions; a volatile memory unit 252 (e.g., random access memory [RAM], static RAM, dynamic RAM, etc.) coupled with bus 250 for storing information and instructions for central processor 251; and a non-volatile memory unit 253 (e.g., read only memory [ROM], programmable ROM, flash memory, etc.) coupled with bus 250 for storing static information and instructions for processor 251. Media server 262 also includes data storage device 254, depicted here as a RAID array (redundant array of inexpensive disks), coupled with bus 250 for storing digital media content. Media server 262 further includes networking module 258, coupled with bus 250, for transmitting and receiving information, e.g., over a network connection.

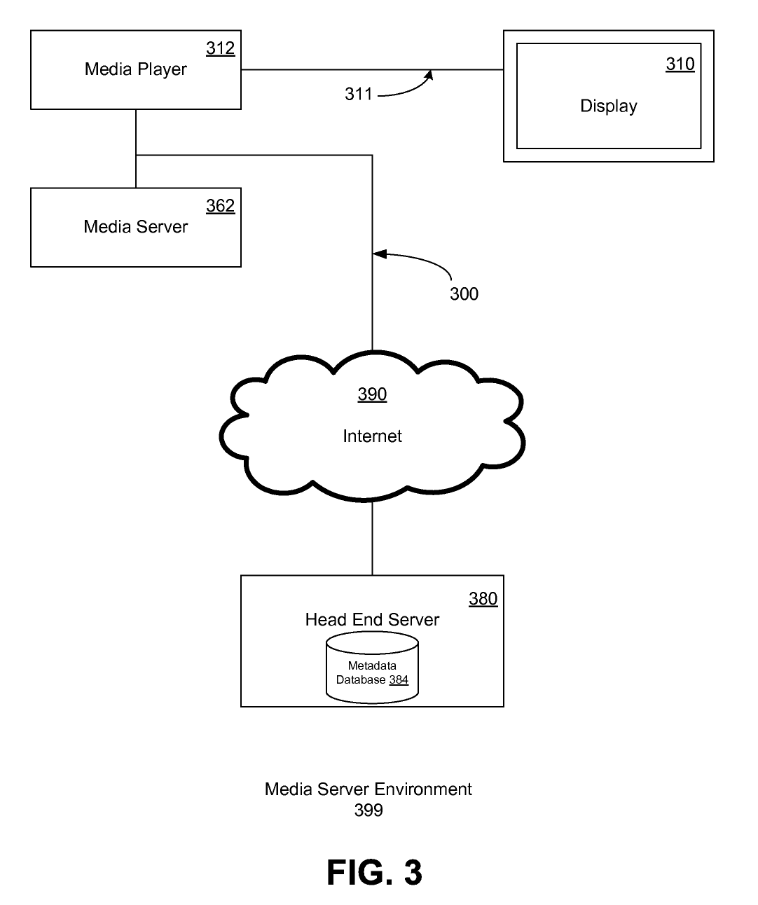

With reference now to FIG. 3, an exemplary media server environment 399 is depicted, in accordance with one embodiment. While media server environment 399 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

In the depicted embodiment, media server 362 is used to store digital media content. Media server 362 is communicatively coupled with media player 312 via network connection 300. Media player 312, in the depicted embodiment, retrieves digital media content from server 362 and plays it back, e.g., by outputting digital video content over video cable 311 to display 310. Media server 362 is also communicatively coupled to a head end database 380, via network connection 300, and the Internet 390. Head end database 380 includes metadata database 384. Media server 362, in this embodiment, is configured to retrieve metadata corresponding to digital content from metadata database 384.

In different embodiments, digital media content may be available from sources other than media server 362. In one such embodiment, for example, media server 362 and/or media player 312 may be able to access or download digital media content from a remote source, e.g., head end database 380, or a remote digital media storage device (not pictured). Similarly, in some embodiments, digital media content may be available in accordance with a digital rights management (DRM) scheme, such as a “rental” scenario where digital media content is available to be viewed for a fixed length of time, or for a specified number of playbacks.

### Control Devices

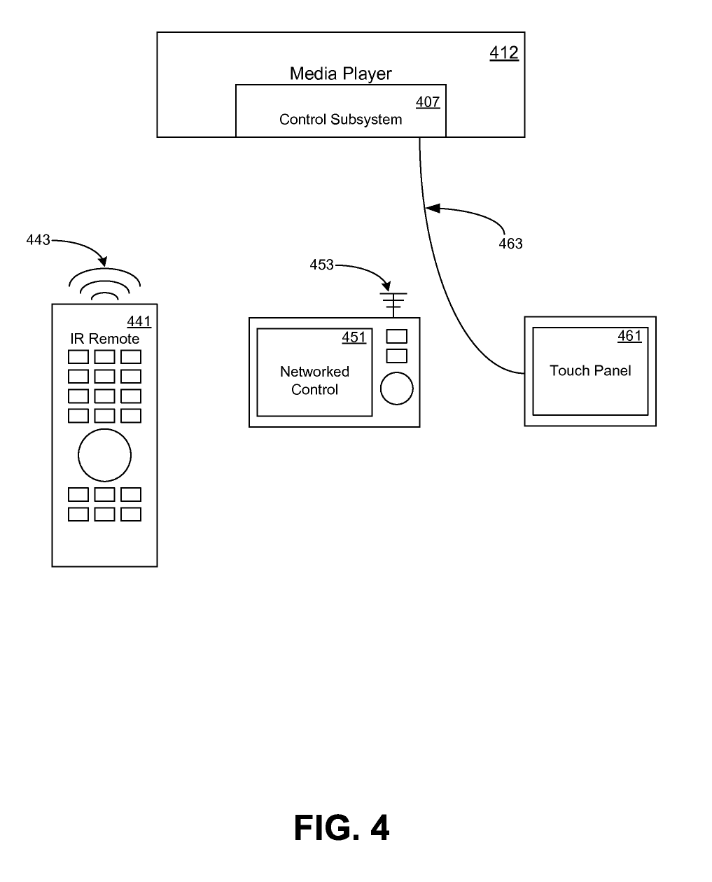

With reference now to FIG. 4, a number of control devices are depicted, which may be used to control the behavior of a media player, such as media player 412. While several different control devices are depicted, it is understood that embodiments are well-suited to applications involving other control methods not depicted herein.

In the depicted embodiment, media player 412 incorporates control subsystem 407. In a media server environment, media players are frequently controlled by one or more of the following: infrared control devices, such as a traditional infrared remote control; networked control devices, either wired (e.g., Ethernet) or wireless (e.g., 802.11); or a wired control device, such as a touch panel device connected via a serial port (e.g., RS-232). FIG. 4 depicts media player 412 being controlled by infrared remote 441 via infrared signal 443, by networking device 451 via wireless signal 453, and touch panel device 461 via serial cable 463. In different embodiments, additional connections or feedback paths not depicted in FIG. 4 may be utilized; e.g., a touch panel interface may incorporate a video feedback path from the media player to the touch panel, in order to display interface elements on the touch panel.

### User Interface

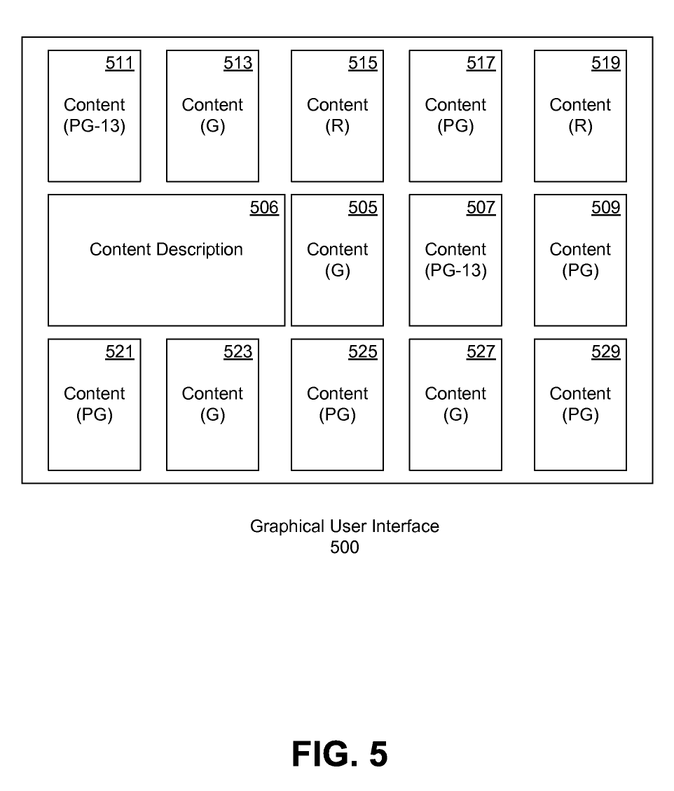

With reference now to FIG. 5, a graphical user interface (GUI) 500 for accessing digital content is depicted, in accordance with one embodiment. While GUI 500 is shown as incorporating specific, enumerated features and elements, it is understood that embodiments are well suited to applications having additional, fewer, or different arrangements of features or elements. In particular, one embodiment incorporates a user interface depicting a listing of digital content available, where digital content may be sorted by a wide selection of available metadata. Moreover, while GUI 500 is depicted as displaying selection elements corresponding to video digital content, it is understood that embodiments are well-suited to applications involving other types of digital content.

In the depicted embodiment, GUI 500 incorporates a number of selection elements corresponding to digital content, specifically video content, available through the device associated with GUI 500. For example, the selection elements of GUI 500 may correspond to digital content stored on a media server, such as media server 362, and available to a user through a media player, such as media player 312. In some embodiments, the selection elements incorporated into GUI 500 indicate what digital content they are associated with; for example, when GUI 500 is displaying selection elements corresponding to video digital content, each selection element may comprise cover art from associated DVD packaging, or an associated movie poster.

In the depicted interface, one selection element is highlighted or otherwise focused upon; e.g., selection element 505. In this embodiment, additional information corresponding to the highlighted selection element is provided via element 506; such information may include a title of the digital content, and a brief description of the digital content. Other selection elements are arranged around the highlighted selection element. In some embodiments, the arrangement of selection elements may change in response to the highlighted selection element. For example, if the selection elements correspond to motion pictures, the selection elements corresponding to motion pictures with the greatest similarity to the highlighted motion picture will be displayed closer to the highlighted selection element. Such similarities may include, but are not limited to, genre, title, cast members, crew members, the year made, any awards nominated or received, running length, or rating. Additionally, in some embodiments, the display of selection elements incorporates a variable factor, such that the arrangement of selection elements within the GUI 500 may vary.

GUI 500 is shown as including selection elements of 505, 507, 509, 511, 513, 515, 517, 519, 521, 523, 525, 527, and 529. As previously noted, in this embodiment the selection elements correspond to video content; for furtherance of discussion, each selection element has been marked with a rating.

### Child Friendly Remote Control

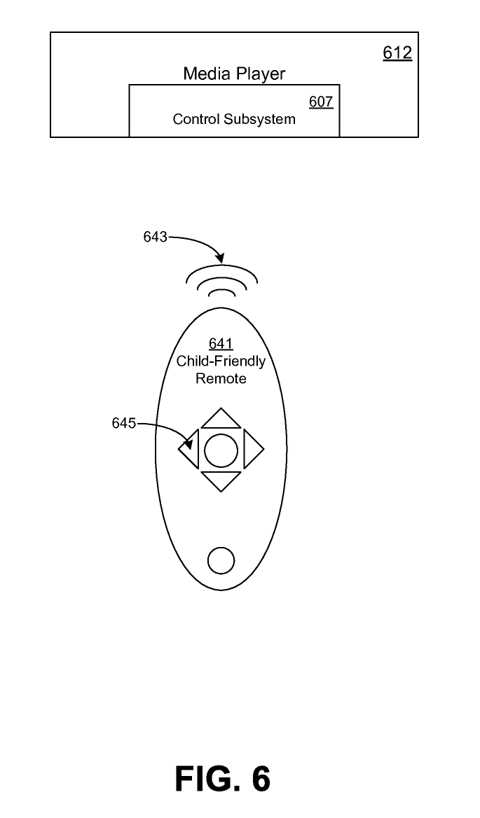

With reference now to FIG. 6, a child friendly remote control 641 is depicted, in accordance with one embodiment. While child friendly remote control 641 is shown as incorporating specific, enumerated features and elements, it is understood that embodiments are well suited to applications having additional, fewer, or different arrangements of features or elements.

In several embodiments, it is desirable that a digital content device should react in a different manner, upon receiving a signal from a particular control device. Specifically, in some embodiments, a media server environment should provide access to limited content and/or functionality upon receiving a signal from a child friendly remote.

In the depicted embodiment, child friendly remote 641 is a limited functionality remote, having a small subset of inputs, as compared with a more complicated remote such as IR remote 441. As shown in FIG. 6, child friendly remote 641 is an infrared remote, and emits IR signal 643. Media player 612, via control subsystem 607, receives IR signal 643, and recognizes that IR signal 643 originated from child friendly remote 641. Accordingly, media player 612 (or, in some embodiments, an associated media server) shifts to a different, e.g., child friendly, mode of operation. This interaction is explored in greater detail below, with reference to FIG. 8.

In some embodiments, the limited number of inputs available from child friendly remote 641 may be mapped to additional functionality during playback of content. For example, arrow key 645 may send a signal to media player 612 which is interpreted as “Left” while navigating a menu, but which media player 612 interprets as “rewind” during playback of digital content.

### Simplified User Interface

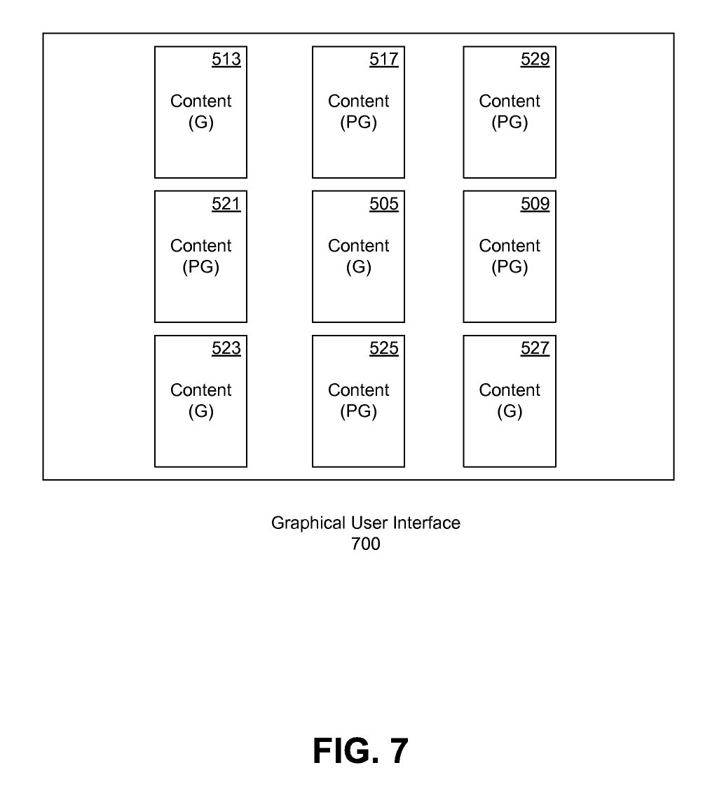

With reference now to FIG. 7, a graphical user interface (GUI) 700 is depicted, in accordance with one embodiment. While GUI 700 is shown as incorporating specific, enumerated features and elements, it is understood that embodiments are well suited to applications having additional, fewer, or different arrangements of features or elements. In particular, one embodiment incorporates a user interface depicting a listing of digital content available, where digital content may be sorted by a wide selection of available metadata. Moreover, while GUI 700 is depicted as displaying selection elements corresponding to video digital content, it is understood that embodiments are well-suited to applications involving other types of digital content.

In some embodiments, it is desirable for the functionality of a digital content device to alter, depending upon the control device used to interface with the content device. In one such embodiment, a child friendly remote, such as child friendly remote 641, is used to control a media player, such as media player 612. GUI 700, in such an embodiment, allows for a simpler interface than GUI 500. In some embodiments, one design consideration is to implement a simplified GUI, e.g., an interface that is easier for a child to navigate, manipulate, and/or utilize. For example, GUI 700 omits a substantial amount of text, e.g., Content Description 506, which a child may not care to or be able to read, while still allowing easy control over selection and playback of available digital content. Moreover, in the depicted embodiment, GUI 700 displays a subset of the digital content available.

In some embodiments, the digital content available through a digital content device can be associated with different collections of content. For example, a user could add some of the video content available on a media server to a “child friendly” collection. Videos added to such a collection are likely to have “G” or “PG” ratings, and to have content that is of interest and appropriate for a child. It is understood that collections can be constructed to suit any need. Moreover, it is understood that, in some embodiments, collections may incorporate different types of digital content, e.g., video and audio content, or content from different sources, e.g., content downloaded via the Internet as well as content extracted from optical media.

In the depicted embodiment, GUI 700 displays a subset of the selection elements from GUI 500, corresponding to the video content having a “G” or “PG” rating. Moreover, GUI 700 omits the text description provided in GUI 500 by element 506; in this embodiment, it is expected that the user of the child friendly interface will select the digital content based solely on the image associated with the selection element, e.g., DVD cover art.

### Method of Operation

With reference now to FIG. 8, a flowchart 800 of a method is depicted, in accordance with one embodiment. Although specific steps are disclosed in flowchart 800, such steps are exemplary. That is, embodiments of the present invention are well suited to performing various other (additional) steps or variations of the steps recited in flowchart 800. It is appreciated that the steps in flowchart 800 may be performed in an order different than presented, and that not all of the steps in flowchart 800 may be performed.

With reference now to step 810, a collection of digital content is defined. In some embodiments, a collection includes a subset of the digital content available on a digital content device. In different embodiments, a collection may be defined in different ways. For example, a user may specifically identify which digital content should be included in a particular collection. Alternatively, a user may choose to exclude certain digital content from a particular collection. A user may set certain preferences, which will be used to define a collection, e.g., include all available movies released before 1950. A collection may be auto-generated, based upon certain characteristics, e.g., if more than three movies with the same director are available, create a collection associated with that director. In other embodiments, collections may be defined in other ways, and/or having different criteria. In different embodiments, the contents of a collection may change, e.g., through addition of additional available content, or removal or previously-available content, or by a change made to the rules which define the collection. In some embodiments, these changes may occur automatically, dynamically changing as the available content changes; in some embodiments, the user may make changes to the collection.

With reference to the preceding figures, video content is stored on a media server, such as media server 262. This video content is accessible via a media player, such as media player 612. A GUI, such as GUI 500, can be used to access video content via selection elements associated with that content. The videos associated with selection elements 505, 509, 513, 517, 521, 523, 525, 527, and 529 are added to a “child friendly” collection. The child friendly collection excludes videos which have a rating higher than “PG.”

With reference now to step 820, a control device is associated with the collection of digital content. In some embodiments, the digital content device can be configured so as to associate a particular control device with the collection of digital content, as well as with certain functionality available via the digital content device. For example, the digital content device can be programmed to recognize a control signal from a specific control device, and to “link” that particular control device with the collection. Alternatively, in some embodiments, all control devices of a particular type may be associated with a particular collection, e.g., all IR remote controls using a particular set of control codes may be associated with the same collection of content. In some embodiments, the contents of a collection may alter, as described above, after the control device has been associated with the collection. In other embodiments, the contents of a collection may be fixed.

With reference to the preceding figures, child friendly remote 641 is associated with the “child friendly” collection of video content.

With reference now to step 830, the control device transmits a control signal. In different embodiments, different methods of transmission may be utilized. For example and without limitation, as previously noted in FIG. 4, control devices may use infrared (IR) signals, radio frequency (RF) signals, TCP/IP packets transmitted via a network connection, or control codes transmitted via a dedicated serial connection.

With reference to the preceding figures, child friendly remote 641 transmits IR signal 643, which is received by control subsystem 607 of media player 612.

With reference now to step 840, the digital content device reacts to the signal from the control device. In some embodiments, the digital content device will recognize the source of the control signal, and react by altering the content and/or functionality available via the control device.

In different embodiments, different approaches are utilized for identifying the source of the control signal. For example, an infrared remote control may be identifiable as using a different set of IR codes than another IR remote; this may be accomplished by having each remote use a completely unique set of codes, or by having each remote use one or more unique codes, such as the IR code for on/off, with the remaining IR codes being common. Alternatively, an IR remote may incorporate an identifying IR code, such that two IR codes are transmitted as part of the control signal, e.g., with the first code identifying the specific remote, and the second code being a standard command code. Similarly, RF controls may use unique control signals, or slightly different frequencies, or combinations of identifying signals and control codes. A control device communicating with a digital content device via a network connection may incorporate additional information via TCP/IP packets sufficient to identify the control device. A similar approach may be utilized in conjunction with a control device communicating via a serial connection.

In different embodiments, the digital content device may react in different ways to the recognized control signal. For example, the digital content device may limit the digital content available to the collection(s) associated with the control device. The digital content device may change the user interface, depending upon which control device is utilized. The digital content device may limit certain functionality, depending upon which control device is utilized. The digital content device may select certain digital content and/or collections to highlight, without limiting the content available via the digital content device. In some embodiments, a digital content device may react differently to the same command issued by different control devices.

With reference to the preceding figures, media player 612 recognizes IR signal 643 as originating from child friendly remote 641, e.g., as child friendly remote 641 uses a different set of IR control codes than IR remote 441. Media player 612 shifts from displaying GUI 500 to the simplified GUI 700, and displays the digital content included in the “child friendly” collection.

In some embodiments, the digital content device may react differently to a control signal received from the control device, depending upon the current state of the digital content device. For example, with reference to the preceding figures, if media player 612 is currently displaying GUI 500 and receives any signal from a child friendly remote 641, it may shift to GUI 700. Child friendly remote 641 may then be used to play back video content associated with one of the displayed selection elements. During playback of the associated video content, control signals received from child friendly remote 641 may be used to manipulate the playback of video content, without causing media player 612 to return to GUI 700.

In some embodiments, the digital content device may respond in other ways to receiving a signal from the child-friendly remote, e.g., by disabling features unlikely to be useful to a user of the child-friendly remote. For example, the digital content device may not display subtitles when a child-friendly remote is used to control it, possibly in contravention of an otherwise global setting. Additionally, users of a child-friendly remote may not be able to choose to import or otherwise obtain additional content, either from physical media or via downloading over a network connection; such a setting may prevent children from inadvertently purchasing downloadable content.

Similarly, in some embodiments, users of a child-friendly remote may be limited in which content may be played. For example, in an embodiment where a child-friendly remote is being used to control a digital content device consisting primarily of a DVD (or other media) player, the DVD may be recognized, and compared against a collection of “allowable” content, in order to determine if the child-friendly remote is allowed to initiate playback of the content on the DVD. In one such embodiment, the media is inserted in the digital content device. An identifier, such as a hash value, is generated or obtained from the media, and compared against a database or list of media, in order to determine what content is stored on the media. Once the media is identified, the content is compared against a collection of content, e.g., a user-specified or automatically-generated collection, in order to determine whether to allow playback of that content. That determination can be used to control whether or not the child-friendly remote is allowed to initiate playback of the content stored on the disc.

Further, in some embodiments, multiple control devices may be utilized. In different embodiments, different control devices may be associated with one or more different collections of digital content. Further, in some embodiments, signals received from one control device may be given priority over those received from another control device, or the functionality of one control device may be limited while the results of a signal from another control device are implemented. For example, media player 612 may receive control signals from both child friendly remote 641 and IR remote 441. If IR remote 441 is used to begin playback of video content, control signals received from child friendly remote 641 may be ignored during playback of the video. However, if child friendly remote 641 is used to initiate playback of video content, control signals from IR remote 441 will still be appropriately processed. Such an embodiment would prevent a child using the child friendly remote from interrupting playback of a video initiated by the “adult” remote control, while still allowing an adult to control the operation of the digital content device at all times.

It is understood that embodiments are not limited to the exemplary “child friendly” implementation described above. For example, embodiments are well suited to applications where multiple control devices may be associated with different collections of content. Such control devices may, in turn, be associated with different individuals (e.g., one remote for each member of the family, each associated with that family member's collection of favorite content), with different tasks (e.g., one remote associated with music playback, one remote associated with video playback, and one remote associated with video game interaction), or with different locations (e.g., one remote, located in the kitchen, associated with a “cooking” collection, and another remote, located in the exercise room, associated with an “exercise” collection).

### General Method

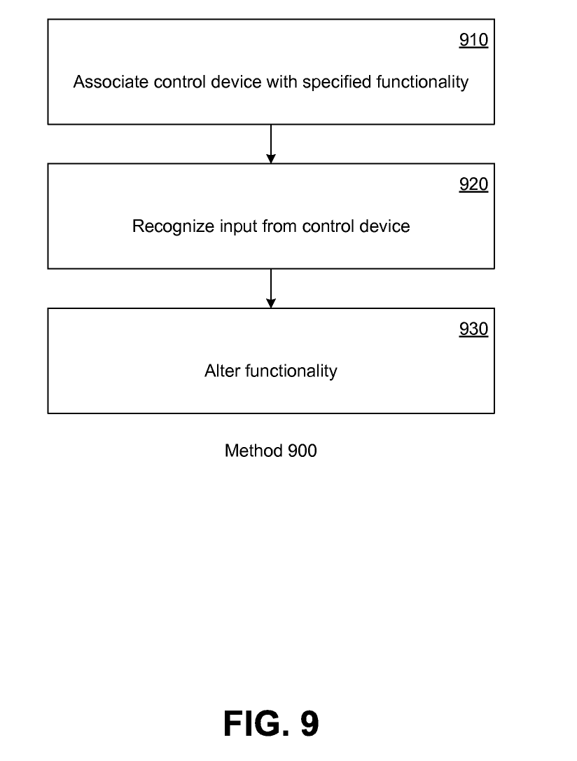

With reference now to FIG. 9, a flowchart 900 of a method is depicted, in accordance with one embodiment. Although specific steps are disclosed in flowchart 900, such steps are exemplary. That is, embodiments of the present invention are well suited to performing various other (additional) steps or variations of the steps recited in flowchart 900. It is appreciated that the steps in flowchart 900 may be performed in an order different than presented, and that not all of the steps in flowchart 900 may be performed.

With reference now to step 910, a control device is associated with certain functionality of the digital content device. In different embodiments, the control device may be implemented in different ways; examples include, but are not limited to, the various control devices described above with reference to FIG. 4. In different embodiments, the association between the control device and the specified functionality of the digital content device may be implemented in different ways. In one such embodiment, the operating system of the digital content device can be configured to implement such an association, e.g., signals received from a specific controller are “linked” to particular functionality or a mode of operation. In different embodiments, the specified functionality associated with the control device may be implemented in different ways. For example, the digital content available through the digital content device may be limited, depending upon the control device used to access the digital content device; for example, a particular control device may be limited to accessing a specific collection of content. Alternatively, the digital content device may allow additional functionality, if a particular control device is utilized; for example, the ability to enable or disable parental control features, e.g., time, rating, or content limitations, may be limited to a single control device.

With reference now to step 920, the digital content device recognizes input from the control device. In different embodiments, this step may be performed in different ways. For example, signals from the control device may be recognized in any of the ways described above, with reference to step 840.

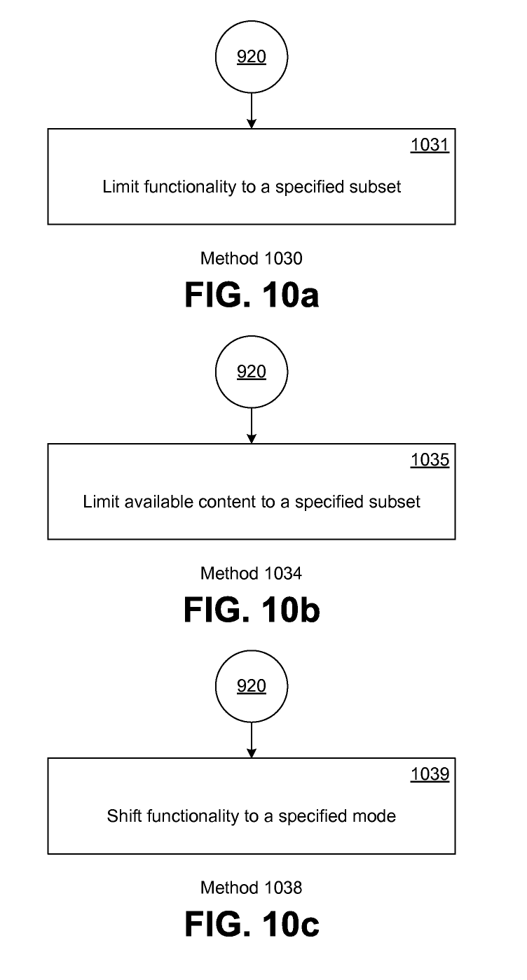

With reference now to step 930, the digital content device alters functionality accordingly. In some embodiments, the digital content device may change to a different mode of operation. In another embodiment, use of a particular control device may trigger or initiate the launch or execution of a particular application. In different embodiments, this step may be incremented in different ways. Several such embodiments are explored in greater detail below, with reference to FIGS. 10a through 10c.

The embodiments described by flowchart 900 offer a number of advantages for accessing and controlling digital content devices. One embodiment, such as that described in flowchart 800, allows for a simplified user experience and a controlled list of digital content, which may be suitable for younger children. Another embodiment allows multiple individuals, through multiple control devices, to personalize their interactions with a digital content device, e.g., the functionality of the user interface and/or which content is most readily accessible. Another embodiment allows for the functionality and more content available through the digital content device to be tailored to the control device used to access it; for example, a guitar shaped video game controller used to access a video game console should have different controls for navigating the game console's interface, and should have ready access to games which utilize that controller.

As described above, several embodiments involve media servers, and the different functionality and/or content available. One embodiment limits which control devices are authorized to perform certain actions, e.g., ordering content, such as downloadable, pay-per-view, purchasable, or adult content. Another embodiment involves digital music collections, e.g., limiting of which portions of a digital music collection are available for playback by a particular control device, or for transferring to a portable digital music player (serving, in this case, as a control device).

In some embodiments, the digital content device may utilize the history of interactions with the control device, when altering functionality. For example, using a particular control device may return the digital content device to a particular state; e.g., if a child-friendly remote is used to control a media server, the initial signal received from the child-friendly remote may return the system to the last state it was in when that remote was used, such as returning to a paused playback position in a movie. As another example, the history of interactions with a particular control device may be used to weight certain content or functionality; e.g., if a child-friendly remote is used to control a media server, the GUI presented may appear focused on a particular favorite movie, as indicated by the number of times it has been selected for playback, or available movies may be ordered with some weight attached to the number of times they have been selected recently.

In some embodiments, a single control device may be utilized to control multiple digital content devices, or to control a single digital content device with multiple access points, e.g., a media server with multiple zones of playback. In one such embodiment, use of the control device in one zone may allow specific behavior to occur when the control device is used in another zone. For example, if a control device is used to initiate playback of music in one zone, using it in another zone may start synchronized playback of music in that second zone. Another example; pausing a media stream during playback in one zone, then using the same control device and hitting “Play” in a second zone may resume playback of the paused media stream, without the user needing to navigate menus or select the paused media stream in some way.

In some embodiments, a digital content device may be able to alter the functionality of a control device. For example, if media player 412 generates the interface for networked control device 451, media player 412 may respond to a input from control device 451 by generating an interface specific to that control device. This approach may allow each user to use their own control device, each having an interface customized to their desires and/or access levels, and/or with access to a particular subset of content. For example, in a multi-user household, each user may have their own networked control device, e.g., a network-enabled smart phone, with an interface at least partially controlled by a media player or server. For each user, the controlling media player could customize the interface, e.g., by displaying a collection of available content associated with that user.

### Specific Embodiments

With reference now to FIGS. 10a, 10b, and 10c, flowcharts of several methods are presented, in accordance with several embodiments. Although specific steps are disclosed in these flowcharts, such steps are exemplary. That is, embodiments of the present invention are well suited to performing various other (additional) steps or variations of the steps recited in the flowcharts. It is appreciated that the steps in the flowcharts may be performed in an order different than presented, and that not all of the steps in the flowcharts may be performed.

With reference now to flowchart 1030, step 1031 continues from step 920 of flowchart 900. Step 1031 involves limiting the functionality of the digital content device, in response to recognizing input from a particular control device. In different embodiments, this step may be implemented in different ways. In one embodiment, for example, receiving a signal from a control device may cause the digital content device to alter the displayed user interface, in order to accommodate the limited input options of the control device.

With reference now to flowchart 1034, step 1035 continues from step 920 of flowchart 900. Step 1035 involves limiting access to digital content available through the digital content device to a specified subset, in response to recognizing input from a particular control device. In different embodiments, this step may be implemented in different ways. In one embodiment, for example, a collection of digital content may be defined, containing a subset of the digital content available through the digital content device, and associated with the control device. The digital content device limits the control device to accessing digital content included in this collection.

With reference now to flowchart 1038, step 1039 continues from step 920 of flowchart 900. Step 1039 involves shifting functionality of the digital content device to a specified mode of operation, in response to recognizing input from a particular control device. In different embodiments, the step is implemented in different ways. In one embodiment, for example, receiving input from a particular control device may cause the digital content device to highlight digital content included in a particular collection associated with that particular control device, while still allowing access to other content, e.g., in response to a signal received from a remote in the kitchen, the digital content device highlights content included in the “cooking” collection, while still allowing the remote to select from other content stored on the digital content device. In another embodiment, receiving input from a particular control device may cause the digital content device to change to a particular mode of functionality, while still allowing access to other functionality, e.g., receiving input from a particular control device may cause the digital content device to shift to an alphabetical listing of content available through the digital content device, while still allowing the control device to change user interface modes if desired.

Embodiments of the present invention are thus described. While the present invention has been described in particular embodiments, it should be appreciated that the present invention should not be construed as limited by such embodiments, but rather construed according to the following claims.

What is claimed is:

1. A method of interacting with a digital content device, comprising:
defining a collection of digital content available via said digital content device;
associating a specific control device with said collection of digital content;
receiving a control signal from said specific control device; and
allowing said specific control device to be used to access digital content included in said collection.

2. The method of claim 1, wherein said collection comprises a plurality of movies.

3. The method of claim 1, wherein said collection comprises digital content approved for a child user.

4. The method of claim 1, wherein said defining comprises automatically selecting a plurality of digital content items available via said digital content device, wherein each of said plurality comprises a similar characteristic.

5. The method of claim 1, wherein said specific control device comprises a remote control unit with limited functionality.

6. The method of claim 1, further comprising:
altering a state of said digital content device upon receipt of said control signal.

7. The method of claim 6, wherein said altering comprises displaying a simplified graphical user interface for use by a child user.

8. A digital content device, comprising:
a processor, for executing software instructions to control said digital content device;
an output module, coupled to said processor, for outputting a signal;
a storage module, coupled to said processor, for storing digital content; and
a control subsystem, coupled to said processor, for receiving a control signal from a control device associated with specific functionality of said digital content device, wherein upon receipt of said control signal from said control device, said processor is configured to allow said control device to access a subset of digital content stored upon said storage module.

9. The digital content device of claim 8, wherein said subset of digital content comprises a collection of digital content items each having a similar characteristic.

10. The digital content device of claim 9, wherein said control device is also associated with said collection of digital content items.

11. The digital content device of claim 8, wherein said processor is further configured, upon receipt of said control signal, to alter a state of said digital content device to allow said control device to interact with said digital content device according to said specific functionality.

12. The digital content device of claim 11, wherein said state comprises displaying a simplified graphical user interface.

13. The digital content device of claim 8, wherein said digital content device comprises a media player.

14. The digital content device of claim 8, wherein said control subsystem is also for receiving a second control signal from a second control device,
wherein upon receipt of said second control signal from said second control device, said processor is configured to allow said second control device to access a second subset of digital content stored upon said storage module.

15. A computer-readable medium having computer-executable instructions for performing a method comprising:
recognizing a control signal from a specific control device; and
reducing the available functionality of a digital content device to a specified mode of operation associated with said specific control device.

16. The computer-readable medium of claim 15, wherein said specified mode of operation comprises limiting access to digital media content available from said digital content device.

17. The computer-readable medium of claim 16, wherein said limiting comprises allowing said specific control device to access a defined collection of digital content items.

18. The computer-readable medium of claim 15, wherein said specified mode of operation comprises displaying a simplified graphical user interface for selecting digital content available from said digital content device.

19. The computer-readable medium of claim 17, wherein said digital content is arranged in a graphical user interface with reference to a history of interactions between said digital content device and said specific control device.

20. The computer-readable medium of claim 15, wherein said control signal comprises a signal received via a networking protocol.
